(19) United States
(12) Patent Application Publication
(10) Pub. No.: US 2024/0157622 A1
(43) Pub. Date: May 16, 2024

(54) PTFE Extrusion

(71) Applicant: J&D Hudson Limited, Bury (GB)

(72) Inventor: Jeremy Hudson, Hebden Bridge (GB)

(21) Appl. No.: 18/284,057

(22) PCT Filed: Mar. 24, 2022
(86) PCT No.: PCT/EP2022/057772

§ 371 Date: Sep. 25, 2023

(30) Foreign Application Priority Data
Mar. 25, 2021 (GB) 2104209.8

(51) Int. Cl. B29C 48/285; B29B 11/10; B29B 11/14; B29C 48/00; B29C 48/25; B29C 48/30; B29C 48/475; B29K 27/18; B29L 31/00

(52) U.S. Cl. CPC B29C 48/2883; B29B 11/10; B29B 11/14; B29C 48/022; B29C 48/252; B29C 48/30; B29C 48/475; B29K 2027/18; B29L 2031/7724

(57) ABSTRACT

A PTFE preform, a PTFE preform forming tool and PTFE extruder and associated methods. PTFE preforms comprise a shape and configuration to facilitate compression and axial advancement within extruder apparatus to provide a resultant exudate that is devoid of internal interfacial surfaces or transitions. The present preforms, apparatus and methods are advantageous to reduce PTFE waste during PTFE manufacturing processes.

### FIELD OF INVENTION

The present invention relates to PTFE extrusion apparatus and methods and in particular, although not exclusively, to apparatus and methods to form a PTFE preform suitable for loading as an extrusion charge within a PTFE extruder and to the method and apparatus of PTFE extrusion.

### BACKGROUND

Processing polytetrafluoroethylene, commonly referred to as PTFE, can be difficult and is cost prohibitive due to its high melt temperature (327° C.) that is above the initial decomposition temperature of 260° C. Even when melted, PTFE does not flow, but instead behaves as a gel due to the absence of a crystalline phase and high melt viscosity. Consequently, PTFE cannot be melt-extruded like most conventional plastics. Typically, PTFE is extruded using a RAM extruder with a process commonly referred to as Paste Extrusion.

Example Paste Extrusion is described for example in U.S. Pat. No. 2,685,707. In particular, a paste extrusion composition is formed by mixing PTFE fine powder with an organic lubricant having a viscosity of at least 0.45 centipoise at 25° C. and being a liquid phase under the conditions of subsequent extrusion. The PTFE soaks up the lubricant, resulting in a dry, pressure coalescing paste extrusion composition that is also referred to as lubricated PTFE fine powder.

The process of paste extrusion utilises an extrusion device having a barrel section and a die section terminated by an extrusion orifice. Lubricated PTFE fine powder, in the form of a cylindrical preform (when formed under pressure) having a flat top and bottom, to conform to chamber. Typically two or more preforms are placed in the chamber and are then ‘paste extruded’ by a ram with one preform pushing out the other at the extrusion orifice. Typically, a mandrel is mounted centrally within the chamber so that the lubricated PTFE fine powder is paste extruded in the form of a sheet, rod, tubing or coating.

For this type of extrusion, the preforms are produced in a separate chamber from the extruder. The mixed material is placed in the chamber which is heated to between 20-50° C. A retaining plate is fastened to the top of the chamber and then a ram is used to compress the mixed material at a pressure between 500 and 2000 PSI. A vacuum may be used to remove air from the material during this process. The preform is then removed and placed into the ram extruder as described. In this state the preforms are extremely brittle and therefore difficult to handle.

Paste extrusion using the preform method is necessarily a batch and discontinuous extrusion operation. When a preform is expelled, from the extruder the extrusion must be stopped, the ram retracted, and another preform loaded into the rear of the extrusion barrel. The trailing end of the preceding preform is still in the barrel, just upstream from the extruder die outlet, and the leading end of the succeeding preform is forced into contact with the trailing end. A junction is created between the two preforms within the barrel. At this junction lubricant can often evaporate and pool on the flat surfaces. This phenomenon occurs with both horizontal and vertical extrusion but is most pronounced in the more common vertical ram extruders. Unfortunately, this junction does not knit together well in the paste extrudate. Air, lubricant, and any other debris trapped between the preforms can result in blisters and breaks in the extrudate as it leaves the extrusion tooling. Accordingly, for extrudate applications, the continuity of the extrudate has to be interrupted where the junction occurs. The pressure of the ram compacting the powder also forms a junction with a subsequent batch of lubricated PTFE fine powder, and when this junction is extruded, non-homogeneous regions develop in the extrudate. This is commonly referred to as the preform joint. This preform joint extrudate is usually waste/scrap, which can result in typical wastage rates of between 10-25%.

The preform joint is particularly disadvantageous for tube production. The differential pressures seen as the preform joint is passed through the tapered part of the cylinder can cause movement of the core pin and the extrusion die as the steady flow of material is impaired. This can also result in a catastrophic loss of concentricity of the extrudate. In the case of a vertical extrusion process, the forces exerted from the ram head are applied directly in a downward direction. As these forces increase, as the preform joint is extruded through the extrusion barrel taper and tooling, the air and lubricant explodes causing ruptures resulting in damage and blisters at the preform joint of the extrudate.

Accordingly, what is required is a PTFE preform, a method of making the same and apparatus and method of PTFE extrusion that solves the above problems.

### SUMMARY OF THE INVENTION

The present disclosure provides several advantages over conventional PTFE preforms suitable for loading as a PTFE preform within paste extrusion apparatus and methods. The present disclosure also provides improved PTFE paste extrusion apparatus and methods to reduce significantly PTFE waste/scrap volumes resultant from the extrusion process. The configuration of the present PTFE preforms is specifically adapted to minimise and preferably eliminate preform joints within the resultant extrudate. In particular, the present apparatus and method is configured specifically to maintain a continuous phase the PTFE composition (PTFE plus lubricant that forms the extrusion paste material) and to avoid specifically separation of the lubricant from the PTFE at the junction between preforms, accumulating at the joint area, within the extrusion chamber/tooling. It is noted, this separation manifests as lubricant pooling or evaporation. The subject concept also minimises and eliminates the likelihood of debris collected or trapped at the junction between the preforms that can result in blisters, cracks and interfaces at the extrudate as it leaves the extrusion tooling, thereby ensuring a stable flow of material which ensures consistent size and concentricity of the extruded product.

Accordingly, the subject apparatus and methods provide a homogenous PTFE extrudate with minimal or no preform joint (or interface) within the paste extrudate. The subject concept is further advantageous to minimise or eliminate ‘explosions’ or ruptures as part of the extrusion process.

The advantages and objectives of the subject invention are achieved via the formation of specifically shaped PTFE paste preforms that are suitable for loading as preforms within PTFE extrusion apparatus. Accordingly, the present concept provides a preform manufacturing process and a subsequent PTFE paste extrusion process and apparatus. In particular, the present PTFE preform comprise conical forward facing and rearward facing surfaces that via their respective acute taper angles (relative to a central longitudinal axis of the extrusion chamber), provide an interference fit as preforms are compressed together by an extrusion ram. Advantageously, a conical forward facing preform surface tapers inwardly towards the central axis by an angle that is less than the angle by which the rearward facing preform surface tapers inwardly. Accordingly, as a rearward preform is forced and compressed against a forward preform, the steeper (or sharper) conical leading surface (of the rear preform) engages into the recessed conical rearward facing surface (of the forward preform) whilst leaving a small air gap created between the two opposed conical mating surfaces. This air gap advantageously provides fluid/gas flow channels, with the gas capable of being transported and/or vented from the extrusion chamber as desired. Additionally, the conical forward facing and rearward facing surfaces are adapted specifically to manage the distribution of compressive forces within the compressed preforms. Accordingly, an extrusion process is provided having the desired control and pressure management to reduce and preferably eliminate undesirable pressure fluctuations at the die orifice. The conical interfaces, as described, further reduce PTFE residue deposits and accumulation within the extrusion tooling due in part to the controlled distribution of loading forces and the facilitated forward advance of the PTFE within the extrusion chamber at the region of the orifice.

Reference within this specification to an acute taper angle, refers to the angle between a longitudinal axis (extending through elongate tooling, a barrel, a preform or mandrel present within the tooling) and a conical surface that extends at a tapered surface aligned transverse to the longitudinal axis. Such an angle is less than 900 and in the case of a forward facing surface of a preform, extends through the material of the preform. In the case of a rearward facing surface of the preform, the acute taper angle does not bisect the material of the preform at its rearward region. As an alternative, the taper angle of the forward facing surface of the preform may be defined as an angle of the conical surface relative to a plane perpendicular to a longitudinal axis of the preform with such an angle being 90° minus the previously defined acute taper angle (that bisects the material of the preform).

According to a first aspect of the present invention there is provided a PTFE preform loadable as an extrusion charge within PTFE extrusion apparatus, the preform comprising: a body having a forward facing surface, an opposite rearward facing surface and a sidewall surface extending axially between the forward facing surface and the rearward facing surface; the forward facing surface being conical and projecting axially forward at the body such that a radially inner region of the forward facing surface is axially forward relative to a radial perimeter of the forward facing surface; the rearward facing surface being conical and recessed into the body such that a radial perimeter of the rearward facing surface is axially rearward relative to a radially inner region of the rearward facing surface; and wherein the sidewall surface is conical and tapers radially inward from the rearward facing surface to the forward facing surface.

Reference within this specification to ‘preform’ encompasses alternative terms including for example billet, charge and blank. This term includes specifically preform blocks of material that may be solid bodies or bodies having an internal bore manufactured into the preform to enable the body to be mounted on a mandrel or core rod extending longitudinally within a barrel of an extruder.

Preferably, an acute taper angle by which the forward facing surface and rearward facing surface extend relative to a longitudinal axis of the preform are different.

Preferably, the acute taper angle of the forward facing surface is less than the acute taper angle of the rearward forward facing surface.

Preferably, an angle by which the acute taper angle of the forward facing surface is less than the acute taper angle of the rearward facing surface is 0.5 to 5°; 0.5 to 3°; 0.5 to 2°, 1 to 5°, 1 to 4° or 1 to 3°.

Preferably, the acute taper angle of the forward facing surface and/or the rearward facing surface relative to the longitudinal axis is in a range 30 to 70°, 35 to 650 or 40 to 60°.

Preferably, an axial length of the forward facing surface and the rearward facing surface are approximately equal.

Preferably, a taper angle by which the sidewall surface extends relative to a longitudinal axis of the preform is less than a taper angle by which the forward facing surface and/or the rearward facing surface extends relative to a longitudinal axis of the preform.

Preferably, an acute taper angle by which the sidewall surface extends relative to a longitudinal axis of the preform is in a range 0.5 to 5°; 0.5 to 30; 0.5 to 2°, 1 to 5°, 1 to 4° or 1 to 3°.

Preferably, the forward facing surface and/or the rearward facing surface are terminated at a radially inner region by a respective circular end surface aligned generally perpendicular to the longitudinal axis for tube/sleeve processing.

According to a further aspect of the present invention there is provided moulding apparatus to form a PTFE preform loadable as an extrusion charge within PTFE extrusion apparatus, the moulding apparatus comprising: a mould body defining an internal chamber to accommodate a PTFE material, the chamber defined by a sidewall surface extending around a central axis, the sidewall surface being conical at least at a first axial region; a first mould block having a first conical surface projecting axially and radially from the sidewall surface and a second mould block having a second conical surface projecting axially and radially from the sidewall surface, a PTFE compression zone definable by a combination of the first and second conical surfaces of the mould blocks and the sidewall surface at the first axial region; a ram movable axially to drive an axial movement of the second mould block within the second axial region of the internal chamber.

Preferably, the barrel of the PTFE preform mould comprises a cylindrical axial section (second axial region) i.e., the sidewall surface at the second axial region is cylindrical. This is advantageous to allow axial transport of the second mould block from a first non-compressive position to a second position at which the PTFE material is fully compressed between the two mould blocks (within the slightly conical first axial region). Advantageously, the moulding apparatus is configured to prevent axial advancement of the second mould block within the conical first axial region of the barrel as this would otherwise result in ‘flashing’ or loss/escape of PTFE material from the compression zone.

Preferably, the first mould block is adjustably mountable at the barrel so as to vary a volume of the compression zone according to different types of PTFE paste material and/or other requirement such as the desired dimensions of the PTFE preform including axial length.

Preferably, an acute angle by which the first conical surface extends relative to the central axis is greater than an acute taper angle by which the second conical surface extends relative to the central axis.

Preferably, the first conical surface comprises an acute taper angle that is 0.5 to 5°; 0.5 to 3°; 0.5 to 2°, 1 to 5°, 1 to 4° or 1 to 3° greater than that of the second conical surface.

Preferably, the acute taper angle of the first and/or second conical surface is in a range 30 to 70°, 35 to 650 or 40 to 60°.

Preferably, a taper angle by which the sidewall surface extends at the first axial region relative to a longitudinal axis is less than a taper angle by which the first and/or second conical surface of the mould block extends relative to a longitudinal axis.

According to a further aspect of the present invention there is provided PTFE extrusion apparatus comprising: an elongate barrel having an internal barrel surface and terminated at one axial end by a die; the die having an extrusion orifice and a conical die surface that tapers radially inward from the internal barrel surface to the extrusion orifice, the barrel surface and die surface defining an internal chamber; a ram movably mountable within the internal chamber and having a conical ram surface to contact a PTFE preform within the internal chamber; wherein an acute taper angle by which the conical ram surface extends relative to a central longitudinal axis of the barrel is greater than an acute taper angle by which the conical die surface extends relative to the longitudinal axis.

Preferably, the ram comprises at least one exhaust aperture to allow a gas to escape from the internal chamber.

Preferably, the ram conical die surface comprises an acute taper angle that is 0.5 to 5°; 0.5 to 3°; 0.5 to 2°, 1 to 5°, 1 to 4° or 1 to 3° greater than that of the conical die surface.

Preferably, the acute taper angle of the ram conical die surface and/or the conical terminal end surface is in a range 30 to 70°, 35 to 65° or 40 to 60°.

Preferably, the internal barrel surface at a first axial region distal to the conical die surface is cylindrical relative to the longitudinal axis. Preferably, the internal barrel surface at a second axial region proximal to the conical die surface and axially intermediate the first axial region and the conical die surface is conical relative to the longitudinal axis so as to taper radially inward in a direction from the first axial region to the conical die surface.

Preferably, an angle by which the internal barrel surface extends at the second axial region relative to the longitudinal axis is in a range 0.5 to 5°; 0.5 to 3°; 0.5 to 2°, 1 to 5°, 1 to 4° or 1 to 3°.

According to a further aspect of the present invention there is provided PTFE extrusion apparatus comprising: an elongate barrel having an internal barrel surface and terminated at one axial end by a die; the die having an extrusion orifice and a conical die surface that tapers radially inward from the internal barrel surface to the extrusion orifice, the barrel surface and die surface defining an internal chamber; a ram movably mountable within the internal chamber and having a ram surface to contact a PTFE preform within the internal chamber; wherein the internal barrel surface at a first axial region distal to the conical die surface is cylindrical relative to the longitudinal axis and the internal barrel surface at a second axial region proximal to the conical die surface and axially intermediate the first axial region and the conical die surface is conical relative to the longitudinal axis so as to taper radially inward in a direction from the first axial region to the conical die surface.

According to a further aspect of the present invention there is provided a method of extruding PTFE comprising: inserting into an extrusion chamber a PTFE preform, the preform comprising a body having a forward facing surface, an opposite rearward facing surface and a sidewall surface extending axially between the forward facing surface and the rearward facing surface; the forward facing surface being conical and projecting axially forward at the body such that a radially inner region of the forward facing surface is axially forward relative to a radial perimeter of the forward facing surface; the rearward facing surface being conical and recessed into the body such that a radial perimeter of the rearward facing surface is axially rearward relative to a radially inner region of the rearward facing surface; and advancing axially a ram within the extrusion chamber to contact the rearward facing surface and compress the PTFE against a die surface and through a die orifice at an axial end of the extrusion chamber.

Preferably, the ram comprises a conical leading surface having an acute taper angle relative to a longitudinal axis of the extrusion chamber that is greater than an acute taper angle by which the conical die surface extends relative to the longitudinal axis. Preferably, the acute taper angle of the forward facing surface of the preform is substantially equal to the acute taper angle of the conical die surface.

Preferably, the sidewall surface of the preform is conical and tapers radially inward in the direction from the rearward facing surface to the forward facing surface.

According to a further aspect of the present invention there is provided the method as claimed herein comprising: stopping the axial advance of the ram within the extrusion chamber at a time when the forward facing surface of an axially rearwardmost preform within the extrusion chamber makes contact with the conical die surface.

Preferably, the method further comprises: withdrawing the ram from the chamber; loading at least one additional PTFE preform into the chamber behind the preform in contact with the conical surface and then axially advancing the ram within the internal chamber.

According to a further aspect of the present invention there is provided a method of moulding a PTFE preform suitable for loading as an extrusion charge within a PTFE extruder, the method comprising: containing a PTFE material within a moulding chamber defined by a sidewall surface having an axial region that is conical, a first conical end surface projecting radially from the sidewall surface and a second conical end surface projecting radially from the sidewall surface; advancing axially a ram within the moulding chamber to drive an axial movement of at least one of the first and second conical end surfaces to reduce a volume of a compression zone defined between the conical sidewall surface and the conical end surfaces to compress the PTFE material within the compression zone between the conical sidewall surface and the first and second conical end surfaces to form a PTFE preform; and; removing the PTFE preform from the internal chamber.

In accordance with aspects of the present concept, a ram axially drivable within a mould or extrusion chamber may be configured for direct or indirect contact with the PTFE material (paste or preform). Where the ram is configured to contact directly to PTFE paste or preform, the ram may be provided with a conical contact surface. According to further embodiments, the ram may be configured for indirect contact with the PTFE paste or preform and may comprise a generally planar contact surface (aligned generally perpendicular to a longitudinal axis of the chamber). In such a configuration the ram is adapted to act on an intermediate block that is, in turn positioned in direct contact with the PTFE paste or preform. Such a block may be attached or attachable to the ram. Optionally, the block having a conical contact surface may be mounted at the internal chamber via a suitable mount so as to be capable of axial movement within the chamber as coupled motion with the axial movement of the ram. With regard to the PTFE forming apparatus and tool, at least one moulding block may be mounted statically at the chamber via a suitable mounting plate or other attachments, fixings and mountings to as to be generally stationary relative to the ram and/or a second moulding block.

### BRIEF DESCRIPTION OF DRAWINGS

A specific implementation of the present invention will now be described, by way of example only, and with reference to the accompanying drawings in which:

FIG. 1 is a perspective view of a PTFE preform suitable for use as a charge loadable into a PTFE extruder;

FIG. 2 is a cross section view of the PTFE preform of FIG. 1;

FIG. 3 is a cross sectional view of a PTFE preform forming tool;

FIG. 4 is a cross section view of a PTFE extruder loaded with two PTFE preforms according to a specific implementation of the present invention;

FIG. 5 is a cross section view of a PTFE extruder loaded with two PTFE preforms according to a further specific implementation of the present invention.

### DETAILED DESCRIPTION OF PREFERRED EMBODIMENT OF THE INVENTION

The subject disclosure provides method and apparatus associated with a PTFE preform and extruder in which the preforms and extrusion apparatus are configured specifically to minimise PTFE waste material. It has been identified that such waste material, according to conventional arrangements, is associated with various factors including the existence of interfacial joints within the PTFE extrudate, the differential speed of extrusion from the extruder, the occurrence of ‘explosions’ of escaping gas, as well as fluctuations in the internal pressure during extrusion.

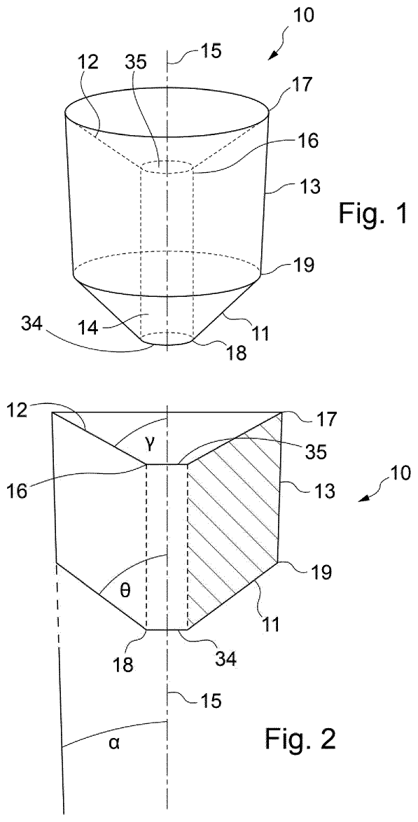

Referring to FIG. 1, a PTFE preform 10 according to the present disclosure comprises a main sidewall surface 13 extending circumferentially around a central longitudinal axis 15. Surface 13 is terminated at an axially rearward end by a rearward facing conical surface 12 recessed into the main body of preform 10. Accordingly, preform 10 comprises a cone shaped cavity or recess at its rearward region. A circular opening 35 provides a forwardmost terminal end of the tapered conical surface 12. Accordingly, surface 12 extends both axially and radially from circular opening 35 (at a radially inner region) to a radial perimeter 17 that forms the junction with the sidewall surface 13.

Preform 10 also comprises an axially forward facing conical surface 11 extending axially forward and radially inward from sidewall surface 13 to represent an axially forwardmost region of preform 10. Surface 13 is terminated by a corresponding circular opening 34 representing the second open end of a bore 14 extending through preform 10 (between surfaces 11 and 12). As with the rearward facing surface 12, the conical forward facing surface 11 extends between a radially innermost end 18 (at the position of opening 34) and an annular perimeter 19 positioned and corresponding to a radially forwardmost region of wall surface 13.

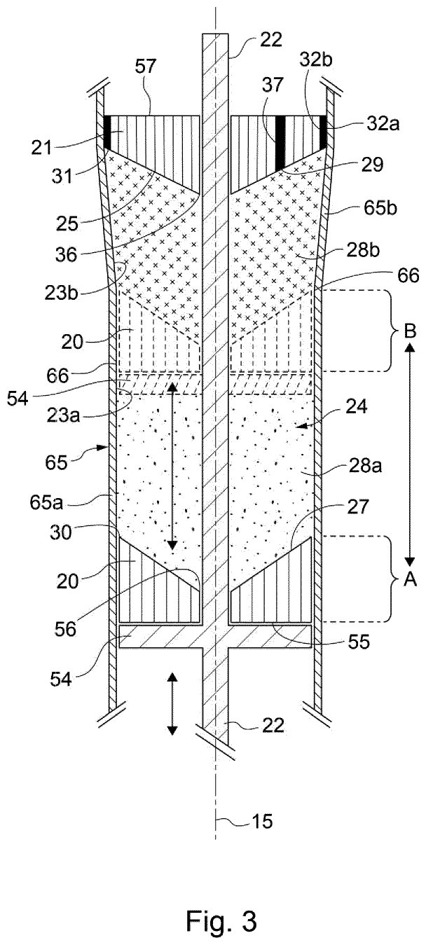

As described, preform 10 is hollow and comprises elongate bore 14 extending axially between the axially rearward facing conical surface 12 and the axially forward facing conical surface 11. Preform 10 may be manufactured as described referring to FIG. 3 in which a central mandrel extends through the preform tool so as to form the central bore 14.

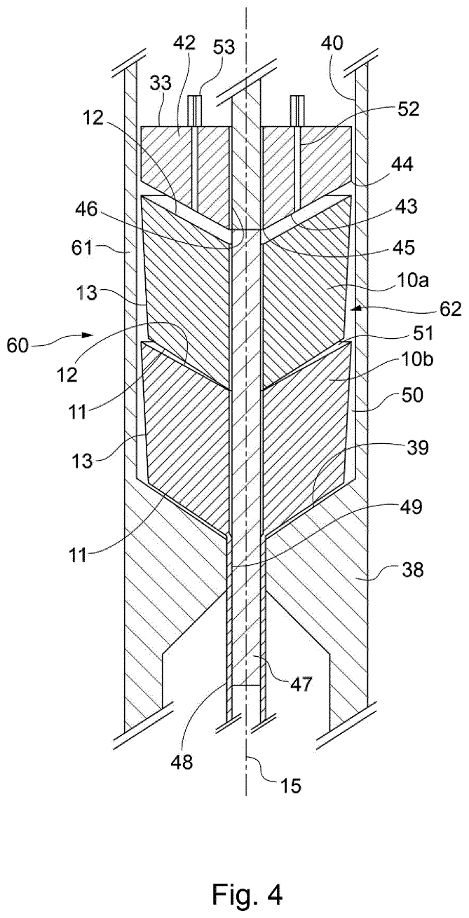

Referring to FIG. 2, preform 10 is symmetrical about axis 15. In the preferred embodiment, sidewall surface 13 is frusto-conical so as to taper radially inward from rearward perimeter 17 to the forward perimeter 19. An angle α by which surface 13 tapers radially inward relative to longitudinal axis 15 may be in the range 0.5 to 5° and may be preferably 1 to 3°. Such a configuration is advantageous to provide a small fluid and in particular gas passageway in the region externally around preform 10 whilst the preform is advanced axially within a barrel of an extruder as described and illustrated referring to FIG. 4.

An acute taper angle θ defined as the angle between surface 11 and central axis 15 is preferably in a range 40 to 60°. Similarly, an acute taper angle γ of rearward facing conical surface 12 relative to longitudinal axis 15 is also in a range 40 to 60°. Advantageously, angle α is less than angle γ. In particular, and according to a preferred implementation, θ is 0.5 to 5° or 1 to 4° less than γ. Accordingly, as a rearward preform is mated into contact with a forward preform within the barrel of an extruder, the forward facing tapered conical surface 11 keys into the rearward facing conical surface 12 of the forwardmost preform via an interference fit. This interference similarly creates a small gap that also provides a fluid/gas passageway. Additionally, as axial preforms are compressed together the compressive forces are better distributed during extrusion. A further advantage of this differential dual conical surface arrangement is to direct loading forces both axially and radially through the preforms 10 within the extruder so as to facilitate the forward advancement of the PTFE material through the barrel and into the extruder orifice. The differential angles θ and γ of the respective forward facing and rearward facing surfaces 11, 12 promotes the transport of PTFE over a corresponding conical die surface of the extruder and facilitates this transport radially inward into the extrusion orifice.

Advantageously, the acute taper angle θ of the forward facing surface 11 is configured to equal a corresponding angle by which the die surface is tapered (via a conical profile relative to longitudinal axis 15 as illustrated referring to FIG. 4). Such an arrangement is further advantageous to distribute the transfer of loading forces and compressive forces within the forwardmost preform 10 as it compressed against the terminal end surface of the extruder die.

According to the specific implementation, an axial length by which each of the forward facing and rearward facing surfaces 11, 12 extend is substantially equal or is approximately equal. The corresponding height or axial length of the preform 10 defined between the forward and rearward perimeters 19, 17 is greater than the corresponding axial distance over which conical surfaces 11, 12 extend. These respective axial lengths of surfaces 11, 12, 13 facilitate safe transportation of the preforms from the preform chamber into the extruder.

Referring to FIG. 3, tooling for the manufacture of PTFE paste preforms is described. Whilst the present specification refers ‘paste’ it will be appreciated that the paste is a powder (with the term paste widely used within the PTFE forming industry). The preform tooling comprises a barrel indicated generally by reference 65, an axially movable ram 54 having a ram head extending radially outward from a central elongate mandrel 22. Ram 54 and mandrel 22 are capable of axial reciprocation within barrel 65 via a hydraulic cylinder (not shown) attached to mandrel 22. Barrel 65 is divided in a direction of longitudinal axis into a second barrel section 65a and a first barrel section 65b. Second barrel section 65a comprises a cylindrical internal facing surface 23a that defines a part of tooling internal chamber 24. Barrel section 65b comprises a slight frusto-conical configuration with internal facing chamber walls 23b being conical and having a taper angle relative to axis corresponding to angle α so as to create the tapered preform sidewall surfaces (as described referring to FIG. 2). Barrel 65 comprises a junction 66 between the second and first barrel sections 65a, 65b with junction 66 providing a step change from the cylindrical surface 23a (aligned parallel to axis 15) and the conical sidewall surface 23b.

The tooling further comprises a first compression block 21 and a second compression block 20. Both blocks 21, 20 comprise a central aperture for mounting about mandrel 22. First block 21 comprises a conical surface 25 extending between a central region 36 (surrounding mandrel 22) and a radial perimeter 31. Block 21 is also defined by a generally circular rear surface 57. At least one bore (or conduit) 37 extends axially through block 21 between surfaces 25 and 57. A poppet valve 29 is mounted at the terminal end of conduit 37 at surface 25 providing a single flow direction valve. Conduit 37 at surface 57 may comprise suitable valves and mountings that allow a vacuum network or pump to be attached to block 21 for the partial evacuation of internal chamber 24 (via conduit 37 and valve 29). A retaining plate (not shown) is secured over block 21 to retain block 21 in fixed static position (axially) within barrel 65 relative to second block 20 and ram 54. The retaining plate (not shown) or other mounting/fixing is preferably adjustably mounted at barrel 65 so as to allow variation of the axial position of block 21 relative to second block 20 and ram 54. The retaining or mounting plate (not shown) providing the adjustable positioning of block 21 is advantageous to achieve precise and predetermined compression of PTFE paste to form the resulting PTFE preforms. That is, the axial fixed mounting position of the first block 21 determines the axial length of the PTFE preform as moulded by the present tooling. Such an arrangement is designed for operation with a movable second block 20 configured for movement to a final terminal position representing a position to provide full compression of the PTFE paste between the two opposed moulding blocks 20, 21. However, once the desired axial position of first part 21 is set, block 21 is statically mounted at barrel 65 so as to be stationary in operation.

Second block 20 similarly comprises an inward facing conical surface 27 extending between a radially inner central region 56 and a radially outer perimeter 30 (positioned at chamber wall surface 23). Blocks 21 and 20 are removably mountable within barrel 65 about mandrel 22 that extends along longitudinal axis 15. An O-ring or seal 32b may be positioned to surround first block 21 at a radially outer facing surface 32a so as to provide a fluid tight seal against chamber internal facing surface 23b.

In operation, ram 54 is withdrawn from a lower end of barrel 65. Second block 20 is then slid over mandrel 22 within chamber 24 to its resting position on ram 54 as illustrated in FIG. 3. A PTFE paste (powder) is then poured into chamber 24. The paste is formed by mixing a PTFE fine powder with an organic lubricant (being liquid under the conditions of subsequent extrusion referring to FIG. 4). The PTFE absorbs the lubricant resulting in a dry paste extrusion composition, typically referred to as lubricated PTFE fine powder. First block 21 is then slid over mandrel 22 into position within barrel 65 to contain the paste in position between the opposed blocks 20, 21. Block 21 is then axially locked in place by the retaining plate (not shown) A partial vacuum is then applied to chamber interior 24 via a suitable vacuum pump (not shown). Simultaneously with the evacuation of chamber 24, ram 54 is advanced axially to compress paste between the opposed blocks 20, 21. According to the preferred mode of operation, material 22 is compressed to approximately ¼ volume within chamber 24 relative to the initial paste/powder state (prior to compression).

Second block 20 via contact of ram 54 with second block forward facing end surface 55, is configured to force axially the second block 20 from a starting position A to the final fixed second position B axially displaced from position A. Position B corresponds to the axial position of junction 66 between the cylindrical ‘pre-chamber’ (defined by cylindrical internal facing surface 23a) and a conical ‘compression zone’ (defined by the conical internal facing surface 23b). In particular, the PTFE paste 28a within the pre-chamber is slowly compressed and forced to travel axially into the compression zone. When second block 20 reaches final position B the PTFE paste 28b is fully compressed and adopts the shape profile and volume defined between the axially separated first and second blocks 21, and the conical internal facing surface 23b at barrel 65. The conical internal facing surface 23b provides a region that is not entered by the second block 20. That is, block 21 does not travel into the compression zone and the region of the conical internal facing surface 23b as this would otherwise result in ‘leakage’ or ‘flashing’ of the PTFE around the annular side surface of second block 20. A corresponding O-ring or other suitable seal (not shown) may be positioned around and against surface (as described referring to seal 32b at first block 21).

As the compressive force onto paste 28b is increased by the action of ram 54 forcing the axial sliding movement of block 20 towards block 21, the paste 28b adopts the corresponding dimensions and shape profile of the preform tool as defined by surfaces 23, and 27 to provide a resulting preform 10 having the shape and configuration described referring to FIGS. 1 and 2.

Referring to FIG. 4, an extruder comprises a generally cylindrical elongate barrel 60 having cylindrical barrel walls 61 with a cylindrical internal facing surface 40 that defines an internal barrel chamber indicated generally by reference 62. A ram 42 comprises a main bore 46 extending axially between a conical forward facing surface 43 and a generally circular (planar) rearward facing surface 33. Ram 42 is capable of axial movement within barrel 60 via sliding along a mandrel 47 that is centred on longitudinal axis 15 and received within bore 46. Ram 42 also comprises a plurality of secondary bores 52 extending between surfaces 43 and 33. A respective valve 53 (optionally a one-way valve) is mounted at each respective rearward terminal end of bores 52. Bores 52 and valve 53 provide a fluid/gas flow conduit for the venting (or evacuation) of fluid/gas from the internal chamber 62. The forward facing conical surface 43 of ram 42 is identical in shape and dimension to the corresponding conical surface 25 of ram 21 (of the PTFE preform forming tool). In particular, the forward facing conical surface 43 of ram 42 comprises an acute taper angle (the acute angle between surface 43 and central longitudinal axis 15) is equal to acute taper angle 7 at the rearward facing surface 12 of preform 10 (referring to FIGS. 1 and 2). Accordingly, ram conical surface 43 is shaped and dimensioned to mirror the shape profile of the conical rearward facing surface 12 of the PTFE preforms 10 and extends between a rearward annular perimeter 44 and a forward inner annular region 45.

Barrel 60 is dimensioned to accommodate multiple preforms 10 with FIG. 4 illustrating a forwardmost preform 10b and a rearward preform 10a positioned axially forward of ram 42. The extruder further comprises a die 38 formed as an axially forward terminal end of barrel 60. Die 38 comprises a conical die surface 39 extending axially and radially from barrel surface 40 towards a central orifice 49 that provides an exit conduit for PTFE material compressed within barrel chamber 62. An acute taper angle by which conical surface 39 extends relative to central longitudinal axis 15 is equal to the acute taper angle θ of the forward facing conical preform surface 11. Mandrel 47 is centred on and extends axially through the orifice 49, the die 38, the barrel chamber 62 and ram 42 via a ram bore 46.

During an extrusion process, the PTFE preforms 10 are loaded into the barrel chamber 62 to form the arrangement of FIG. 4 with forward and rearward PTFE preforms 10b, 10a. Due to the difference in acute taper angle θ and γ, a small gap or passageway 51 is created between the rearward facing and forward facing conical surfaces 12, 11. Additionally, and according to the specific implementation, a narrow passageway 50 is also created between the preform sidewall surface 13 and the barrel chamber internal surface 40 resultant from the slight conical shape profile of sidewall surface 13 (having acute taper angle α) and the cylindrical internal facing surface 40 of barrel walls 61. With the PTFE preforms 10b, 10a loaded into chamber 62 and centred around a mandrel 47, ram 42 is mounted at the trailing end of chamber 62 with forward facing conical surface 43 opposed to preform rearward facing conical surface 12. As ram 42 is advanced axially to compress preform 10a, preform forward facing surface 11 keys into the rearward facing surface 12 of the forward preform 10b. Advantageously, the conical passageway 51 between the opposed preforms 10b, 10a provides an exhaust conduit for lubricant separated from the PTFE paste. This arrangement avoids specifically pooling, blistering and debris collection at the interface between preforms 10b, 10a. The annular passageway 50 around the sidewall surfaces 13 of the preforms 10b, 10a facilitates the rearward transport of any lubricant gas and/or liquid that is capable of being vented/evacuated from internal chamber 62 via ram bores 52 and valves 53. As indicated, the respective taper angles θ and γ facilitate the control of the compression forces at the junction between the preforms 10b, 10a and, in particular, the axial forward transport of the PTFE within the chamber 62 and into contact with the conical die surface 39. The acute taper angle θ of the preform forward facing surface 11 being equal to the corresponding acute taper angle of the die surface 39 greatly facilitates the controlled forward transport of PTFE at the die 38 and into the orifice 49. Importantly, PTFE material at the radial perimeter of preform 10b is encouraged to flow radially inward due to the matching conical tapered surfaces 11, 39. Such an arrangement also reduces PTFE residue collecting at die surface 39 and/or the axially forward regions of barrel surface 40. The PTFE is then extruded through orifice 49 as a continuous and homogenous extrudate 48 devoid of any internal interfacial regions or surfaces.

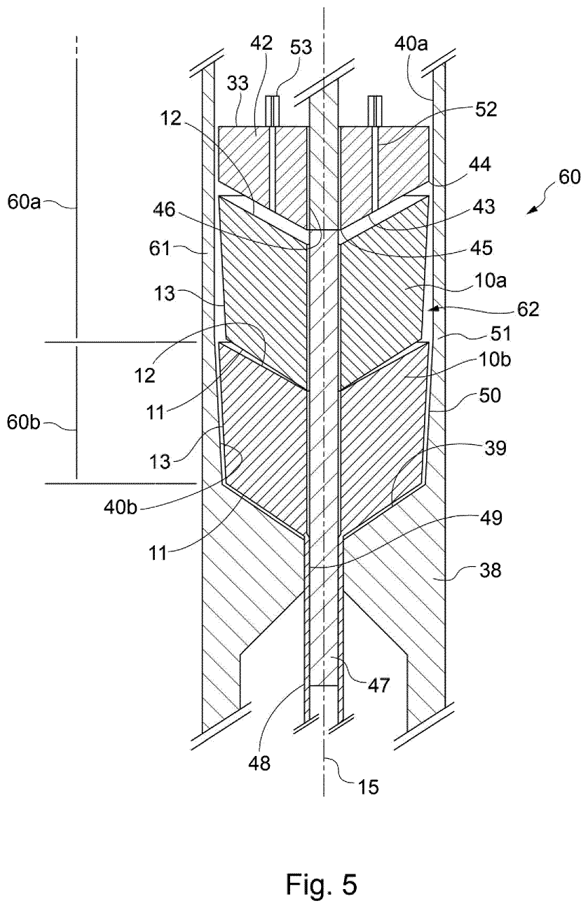

A further embodiment of a PTFE extruder is describe referring to FIG. 5. The features and function of the embodiment described referring to FIG. 4 are common to the further embodiment of FIG. 5 save for elongate barrel 60 and in particular barrel walls 61 having an internal facing surface that, in part, defines the internal barrel chamber 62. According to the further embodiment of FIG. 5, barrel 60 is divided axially into a first axial region 60a and a second axial region 60b. Region 60a is positioned axially furthest from die surface 39 (so as to be distal to die surface 39) relative to second region 60b that is positioned axially closest and immediately adjacent die surface 39 (so as to be proximal to die surface 39). Accordingly, second region 60b is positioned axially intermediate region 60a and die surface 39. According to the specific implementation, the barrel internal facing surface 40a at first region 60a is generally cylindrical relative to axis 15. The barrel internal facing surface 40b at second region 60b is generally conical relative to longitudinal axis 15 so as to taper radially inward in a direction from first region 60a to die surface 39. Accordingly, a diameter of barrel internal facing surface 40b axially furthest from die surface 39 is greater than a diameter of barrel internal facing surface 40b axially closest and immediately adjacent (proximal) to die surface 39.

Furthermore, according to the specific implementation, barrel internal facing surface 40b having the slight frusto-conical configuration comprises a taper angle relative to the longitudinal axis 15 corresponding to angle. This creates a corresponding tapered internal facing surface to match and mate closely with the tapered external facing sidewalls of the preforms 10a, 10b. Such a configuration is advantageous to provide a constant extrusion speed (at a fixed pressure). The barrel internal facing surface at the junction of regions 60a and 60b may be a step-change (from cylindrical to conical) or may be gradual via a curved or tapered region axially intermediate regions 60a and 60b.

According to the present implementations described herein, a pump and vacuum manifold (not shown) may be attachable to conduits/bores 37,52 (and/or valves 53) so as to apply a partial vacuum to barrel internal chambers 24,62. Such a partial vacuum may facilitate the exhaust of lubricant separated from the PTFE paste that forms preforms 10b, 10a.

The present concept has been described with specific reference to ‘tube’ (and ‘wire sleeving’) extrusion that utilises a mandrel or core rod. However, the present preforms, apparatus and processes relate equally to ‘rod’ extrusion in which the preforms are solid and the extrusion tooling does not include an elongate mandrel or core rod. Accordingly, the preforms of the present concept (having the respective conical/tapered surfaces) can be utilised with both tube and rod extrusion methods and the advantages mentioned herein are relevant to both.

1. A PTFE preform loadable as an extrusion charge within PTFE extrusion apparatus, the preform comprising:
a body having a forward facing surface, an opposite rearward facing surface and a sidewall surface extending axially between the forward facing surface and the rearward facing surface;
the forward facing surface being conical and projecting axially forward at the body such that a radially inner region of the forward facing surface is axially forward relative to a radial perimeter of the forward facing surface;
the rearward facing surface being conical and recessed into the body such that a radial perimeter of the rearward facing surface is axially rearward relative to a radially inner region of the rearward facing surface; and
wherein the sidewall surface is conical and tapers radially inward from the rearward facing surface to the forward facing surface.

2. The preform as claimed in claim 1 wherein an acute taper angle by which the forward facing surface and rearward facing surface extend relative to a longitudinal axis of the preform are different.

3. The preform as claimed in claim 2 wherein the acute taper angle of the forward facing surface is less than the acute taper angle of the rearward forward facing surface.

4. The preform as claimed in claim 3 wherein an angle by which the acute taper angle of the forward facing surface is less than the acute taper angle of the rearward facing surface is 0.5 to 5°; 0.5 to 3°; 0.5 to 2°, 1 to 5°, 1 to 4° or 1 to 3°.

5. The preform as claimed in claim 2 wherein the acute taper angle of the forward facing surface and/or the rearward facing surface relative to the longitudinal axis is in a range 30 to 70°, 35 to 65° or 40 to 60°.

6. The preform as claimed in claim 1 wherein an axial length of the forward facing surface and the rearward facing surface are approximately equal.

7. The preform as claimed in claim 1 wherein a taper angle by which the sidewall surface extends relative to a longitudinal axis of the preform is less than a taper angle by which the forward facing surface and/or the rearward facing surface extends relative to a longitudinal axis of the preform.

8. The preform as claimed in claim 7 wherein an acute taper angle by which the sidewall surface extends relative to a longitudinal axis of the preform is in a range 0.5 to 5°; 0.5 to 3°; 0.5 to 2°, 1 to 5°, 1 to 4° or 1 to 3°.

9. The preform as claimed in claim 1 wherein the forward facing surface and/or the rearward facing surface are terminated at a radially inner region by a respective circular end surface aligned generally perpendicular to the longitudinal axis.

10. Moulding apparatus to form a PTFE preform loadable as an extrusion charge within PTFE extrusion apparatus, the moulding apparatus comprising:
a mould body defining an internal chamber to accommodate a PTFE material, the chamber defined by a sidewall surface extending around a central axis, the sidewall surface being conical at least at a first axial region;
a first mould block having a first conical surface projecting axially and radially from the sidewall surface and a second mould block having a second conical surface projecting axially and radially from the sidewall surface,
a PTFE compression zone definable by a combination of the first and second conical surfaces of the mould blocks and the sidewall surface at the first axial region;
a ram movable axially to drive an axial movement of the second mould block within a second axial region of the internal chamber.

11. The apparatus as claimed in claim 10 wherein an acute angle by which the first conical surface extends relative to the central axis is greater than an acute taper angle by which the second conical surface extends relative to the central axis.

12. The apparatus as claimed in claim 11 wherein the first conical surface comprises an acute taper angle that is 0.5 to 5°; 0.5 to 3°; 0.5 to 2°, 1 to 5°, 1 to 4° or 1 to 3° greater than that of the second conical surface.

13. The apparatus as claimed in claim 10 wherein the acute taper angle of the first and/or second conical surface is in a range 30 to 70°, 35 to 65° or 40 to 60°.

14. The apparatus as claimed in claim 10 wherein a taper angle by which the sidewall surface extends at the first axial region relative to a longitudinal axis is less than a taper angle by which the first and/or second conical surface of the mould block extends relative to a longitudinal axis.

15. The apparatus as claimed in claim 10 wherein the sidewall surface at the second axial region is cylindrical.

16. PTFE extrusion apparatus comprising:
an elongate barrel having an internal barrel surface and terminated at one axial end by a die;
the die having an extrusion orifice and a conical die surface that tapers radially inward from the internal barrel surface to the extrusion orifice, the barrel surface and die surface defining an internal chamber;
a ram movably mountable within the internal chamber and having a conical ram surface to contact a PTFE preform within the internal chamber;
wherein an acute taper angle by which the conical ram surface extends relative to a central longitudinal axis of the barrel is greater than an acute taper angle by which the conical die surface extends relative to the longitudinal axis.

17. The apparatus as claimed in claim 16 wherein the ram comprises at least one exhaust aperture to allow a gas to escape from the internal chamber.

18. The apparatus as claimed in claim 16 wherein the conical ram surface comprises an acute taper angle that is 0.5 to 5°; 0.5 to 3°; 0.5 to 2°, 1 to 5°, 1 to 4° or 1 to 3° greater than that of the conical die surface.

19. The apparatus as claimed in claim 16 wherein the acute taper angle of the conical ram surface and/or the conical die surface is in a range 30 to 70°, 35 to 65° or 40 to 60°.

20. The apparatus as claimed in claim 16 wherein the internal barrel surface at a first axial region distal to the conical die surface is cylindrical relative to the longitudinal axis.

21. The apparatus as claimed in claim 16 wherein the internal barrel surface at a second axial region proximal to the conical die surface and axially intermediate the first axial region and the conical die surface is conical relative to the longitudinal axis so as to taper radially inward in a direction from the first axial region to the conical die surface.

22. The apparatus as claimed in claim 21 wherein an acute angle by which the internal barrel surface extends at the second axial region relative to the longitudinal axis is in a range 0.5 to 5°; 0.5 to 3°; 0.5 to 2°, 1 to 5°, 1 to 4° or 1 to 3°.

23. A method of extruding PTFE comprising:
inserting into an extrusion chamber a PTFE preform, the preform comprising a body having a forward facing surface, an opposite rearward facing surface and a sidewall surface extending axially between the forward facing surface and the rearward facing surface; the forward facing surface being conical and projecting axially forward at the body such that a radially inner region of the forward facing surface is axially forward relative to a radial perimeter of the forward facing surface; the rearward facing surface being conical and recessed into the body such that a radial perimeter of the rearward facing surface is axially rearward relative to a radially inner region of the rearward facing surface; and
advancing axially a ram within the extrusion chamber to contact the rearward facing surface and compress the PTFE against a die surface and through a die orifice at an axial end of the extrusion chamber.

24. The method as claimed in claim 23 wherein the ram comprises a conical leading surface having an acute taper angle relative to a longitudinal axis of the extrusion chamber that is greater than an acute taper angle by which the conical die surface extends relative to the longitudinal axis.

25. The method as claimed in claim 23 wherein the acute taper angle of the forward facing surface of the preform is substantially equal to the acute taper angle of the conical die surface.

26. The method as claimed in claim 23 wherein the sidewall surface of the preform is conical and tapers radially inward in the direction from the rearward facing surface to the forward facing surface.

27. The method as claimed in claim 23 comprising:
stopping the axial advance of the ram within the extrusion chamber at a time when the forward facing surface of an axially rearwardmost preform within the extrusion chamber makes contact with the conical die surface.

28. The method as claimed in claim 27 further comprising:
withdrawing the ram from the chamber;
loading at least one additional PTFE preform into the chamber behind the preform in contact with the conical surface and then axially advancing the ram within the internal chamber.

29. A method of moulding a PTFE preform suitable for loading as an extrusion charge within a PTFE extruder, the method comprising:
containing a PTFE material within a moulding chamber defined by a sidewall surface having an axial region that is conical, a first conical end surface projecting radially from the sidewall surface and a second conical end surface projecting radially from the sidewall surface;
advancing axially a ram within the moulding chamber to drive an axial movement of at least one of the first and second conical end surfaces to reduce a volume of a compression zone defined between the conical sidewall surface and the conical end surfaces to compress the PTFE material within the compression zone between the conical sidewall surface and the first and second conical end surfaces to form a PTFE preform; and
removing the PTFE preform from the internal chamber.
